(19) United States
(12) Patent Application Publication
(10) Pub. No.: US 2025/0138152 A1
(43) Pub. Date: May 1, 2025

(54) TECHNIQUES FOR UPDATING AN ARTIFICIAL INTELLIGENCE OR MACHINE LEARNING MODEL FOR OBJECT RECOGNITION

(71) Applicant: QUALCOMM Incorporated, San Diego, CA (US)

(72) Inventors: Mingxi YIN, Beijing (CN); Min HUANG, Beijing (CN); Chenxi HAO, Beijing (CN); Hao XU, Beijing (CN); Danlu ZHANG, San Diego, CA (US)

(21) Appl. No.: 18/497,488

(22) Filed: Oct. 30, 2023

(51) Int. Cl. G01S 7/41; G01S 7/00

(52) U.S. Cl. CPC G01S 7/415; G01S 7/006

(57) ABSTRACT

Various aspects of the present disclosure generally relate to wireless communication. In some aspects, a wireless communication device may transmit an indication of micro-Doppler measurements associated with a first artificial intelligence or machine learning (AI/ML) model. The wireless communication device may receive, in association with transmitting the indication of the micro-Doppler measurements, an indication of a second AI/ML model that is an update of the first AI/ML model. The wireless communication device may transmit, in connection with using the second AI/ML model, an indication associated with object recognition. Numerous other aspects are described.

### FIELD OF THE DISCLOSURE

Aspects of the present disclosure generally relate to wireless communication and to techniques and apparatuses for updating an artificial intelligence or machine learning model for object recognition.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a wireless communication device. The method may include transmitting an indication of micro-Doppler measurements associated with a first artificial intelligence or machine learning (AI/ML) model. The method may include receiving, in association with transmitting the indication of the micro-Doppler measurements, an indication of a second AI/ML model that is an update of the first AI/ML model. The method may include transmitting, in connection with using the second AI/ML model, an indication associated with object recognition.

Some aspects described herein relate to a method of wireless communication performed by a wireless communication device. The method may include receiving an indication of micro-Doppler measurements associated with a first AI/ML model. The method may include transmitting, in association with transmitting the indication of the micro-Doppler measurements, an indication of a second AI/ML model that is an update of the first AI/ML model.

Some aspects described herein relate to a wireless communication device for wireless communication. The wireless communication device may include one or more memories and one or more processors coupled to the one or more memories. The one or more processors may be configured to transmit an indication of micro-Doppler measurements associated with a first AI/ML model. The one or more processors may be configured to receive, in association with transmitting the indication of the micro-Doppler measurements, an indication of a second AI/ML model that is an update of the first AI/ML model. The one or more processors may be configured to transmit, in connection with using the second AI/ML model, an indication associated with object recognition.

Some aspects described herein relate to a wireless communication device for wireless communication. The wireless communication device may include one or more memories and one or more processors coupled to the one or more memories. The one or more processors may be configured to receive an indication of micro-Doppler measurements associated with a first AI/ML model. The one or more processors may be configured to transmit, in association with transmitting the indication of the micro-Doppler measurements, an indication of a second AI/ML model that is an update of the first AI/ML model.

Some aspects described herein relate to a non-transitory computer-readable medium that stores a set of instructions for wireless communication by a wireless communication device. The set of instructions, when executed by one or more processors of the wireless communication device, may cause the wireless communication device to transmit an indication of micro-Doppler measurements associated with a first AI/ML model. The set of instructions, when executed by one or more processors of the wireless communication device, may cause the wireless communication device to receive, in association with transmitting the indication of the micro-Doppler measurements, an indication of a second AI/ML model that is an update of the first AI/ML model. The set of instructions, when executed by one or more processors of the wireless communication device, may cause the wireless communication device to transmit, in connection with using the second AI/ML model, an indication associated with object recognition.

Some aspects described herein relate to a non-transitory computer-readable medium that stores a set of instructions for wireless communication by a wireless communication device. The set of instructions, when executed by one or more processors of the wireless communication device, may cause the wireless communication device to receive an indication of micro-Doppler measurements associated with a first AI/ML model. The set of instructions, when executed by one or more processors of the wireless communication device, may cause the wireless communication device to transmit, in association with transmitting the indication of the micro-Doppler measurements, an indication of a second AI/ML model that is an update of the first AI/ML model.

Some aspects described herein relate to an apparatus for wireless communication. The apparatus may include means for transmitting an indication of micro-Doppler measurements associated with a first AI/ML model. The apparatus may include means for receiving, in association with transmitting the indication of the micro-Doppler measurements, an indication of a second AI/ML model that is an update of the first AI/ML model. The apparatus may include means for transmitting, in connection with using the second AI/ML model, an indication associated with object recognition.

Some aspects described herein relate to an apparatus for wireless communication. The apparatus may include means for receiving an indication of micro-Doppler measurements associated with a first AI/ML model. The apparatus may include means for transmitting, in association with transmitting the indication of the micro-Doppler measurements, an indication of a second AI/ML model that is an update of the first AI/ML model.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of unmanned aerial vehicle (UAV) UEs within a wireless communication network environment, in accordance with the present disclosure.

FIG. 5 is a diagram illustrating an example architecture of a functional framework for radio access network (RAN) intelligence enabled by data collection, in accordance with the present disclosure.

FIGS. 6A-6G are diagrams illustrating an example associated with updating AI/ML model for object recognition, in accordance with the present disclosure.

FIG. 7 is a diagram illustrating an example process performed, for example, at a wireless communication device or an apparatus of a wireless communication device, in accordance with the present disclosure.

FIG. 8 is a diagram illustrating an example process performed, for example, at a network node or an apparatus of a wireless communication device, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some communications systems, artificial intelligence or machine learning (AI/ML) models may be deployed at different devices to perform determination or prediction tasks. For example, a user equipment (UE) may use an AI/ML model to predict a beam or a set of parameters of a beam that the UE is to use during a handover scenario. Similarly, a UE may use an AI/ML model for object recognition (e.g., using a camera of the UE). Some communications systems incorporate unmanned aerial vehicles (UAVs) to perform tasks, such as providing coverage extension (e.g., as a repeater), performing monitoring (e.g., meteorological monitoring, environmental monitoring), low-altitude airspace and ground management (e.g., sensing of other UAVs, sensing of vehicles, sensing of pedestrians), mapping, intruder detection, or other use cases. Additionally, or alternatively, UAVs may perform gesture recognition, vital signal detection, high-resolution imaging, sensing assisted communication (e.g., beam management) or other tasks. Although some aspects are described herein in terms of UAVs, it is contemplated that aspects described herein may be used for object detection and collision avoidance in connection with other objects, such as birds, vehicles, or pedestrians, among other examples.

To avoid collisions and/or for other sensing tasks, some UAVs may perform object detection procedures. For example, a UAV may detect a presence of a bird, and may avoid the detected bird when moving between locations. Additionally, or alternatively, a UAV may identify and classify another UAV, which may enable collision avoidance, sensing coordination, airspace detection, or other tasks. One sensor type that a UAV may use to perform object detection is a camera sensor. For example, a UAV may use an AI/ML computer vision algorithm to detect a presence of a bird in imaging of a scene. Another sensor type that the UAV may use is a Doppler effect sensor. In this case, the UAV may detect a micro-Doppler effect and may process variations in an observed micro-Doppler effect to detect a rotor (e.g., a propeller) rotation of another UAV, a wing flapping of a bird, an arm motion of a walking pedestrian, or a wheel rotation of a vehicle. Additionally, or alternatively, the UAV may use micro-Doppler variations to detect characteristics of an object, such as a rotor size, a rotor number, a rotor velocity, or another characteristic of another UAV. Micro-Doppler effect sensing includes the processing of Doppler shifts detected from micro-scale movements (e.g., a micro-Doppler spectrum), using AI/ML models, to infer object detection or object characteristics.

However, a micro-Doppler spectrum processing may be resource intensive, which may prevent a sensing UAV from performing object detection tasks using an AI/ML model. Accordingly, the AI/ML model may be offloaded to another device, such as a UE and/or a network node. The UE and/or the network node may receive sensing measurements, generate a prediction (e.g., identify an object), and transmit an indication of the prediction, which enables the sensing UAV to, for example, avoid the identified object. As an example, the sensing UAV may control flight in a first manner to avoid another UAV and in a second manner to avoid a bird. However, conveying a micro-Doppler spectrum may be data intensive and may have a relatively large signaling overhead. A UAV could reduce the signaling overhead by having a UE perform a prediction locally and report a result of the prediction without communicating with a network node. However, a single, general AI/ML model deployed at the UE, to perform generalized predictions (e.g., a different levels of micro-Doppler features, for different types of sensing, etc.) may have a low level of accuracy. Further, deploying a plurality of models, at a UE, concurrently may result in excessive utilization of data storage at the UE.

Some aspects described herein enable updating AI/ML models for object detection. For example, a UE may receive micro-Doppler measurements and may request an AI/ML update of a first AI/ML model deployed at the UE. The request may include information regarding the micro-Doppler measurements, such as a level of granularity or confidence with the micro-Doppler measurements or a type of sensing that is to be performed (e.g., sensing of a classification of an object, such as a bird or UAV, or sensing of a characteristic of a particular type of object, such as a number of rotors of a UAV). The request may be less resource intensive than full AI/ML prediction offloading, thereby reducing signaling overhead. The UE may receive, from a network node, a response with an AI/ML update, which configures a second AI/ML model at the UE (e.g., an entirely new AI/ML model or an update or change of parameters of the first AI/ML model). The UE can use the second AI/ML model, which may have a higher level of accuracy than the first AI/ML model, and report a result of using the AI/ML model to the UAV.

In this way, the UE, the network node, and/or the UAV enable improved prediction (e.g., object recognition) for UAVs that are offloading predictions to another wireless communication device, such as to UEs. By improving prediction, the UE enables improved flight characteristics, improved completion of sensing tasks, and/or reduced likelihood of damage (e.g., resulting from collisions) relative to less accurate prediction.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

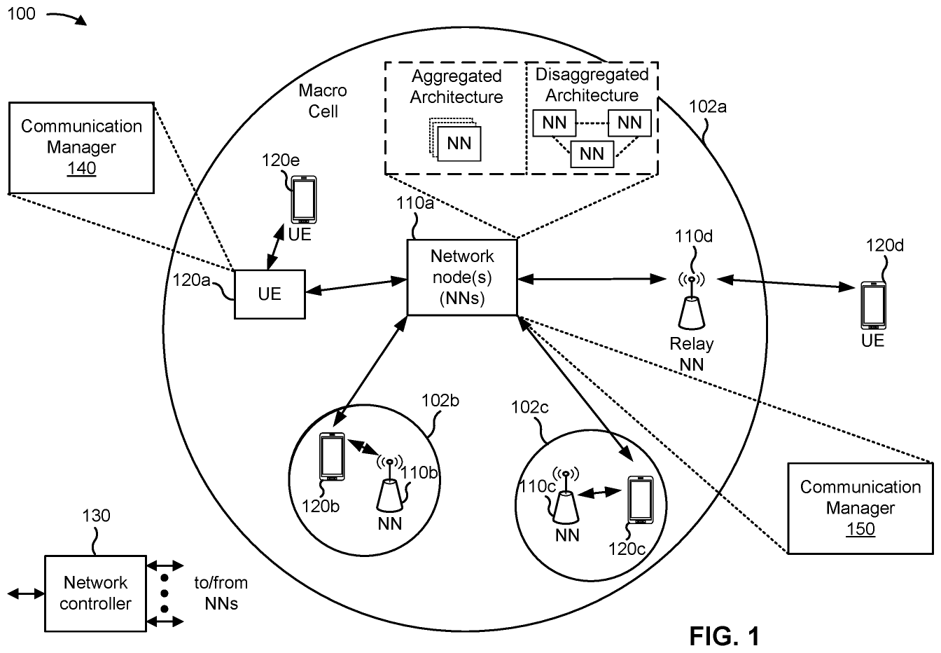

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE 120 may include a communication manager 140. As described in more detail elsewhere herein, the communication manager 140 may transmit an indication of micro-Doppler measurements associated with a first AI/ML model; receive, in association with transmitting the indication of the micro-Doppler measurements, an indication of a second AI/ML model that is an update of the first AI/ML model; and transmit, in connection with using the second AI/ML model, an indication associated with object recognition. Additionally, or alternatively, the communication manager 140 may perform one or more other operations described herein.

In some aspects, the network node 110 may include a communication manager 150. As described in more detail elsewhere herein, the communication manager 150 may receive an indication of micro-Doppler measurements associated with a first AI/ML model; and transmit, in association with transmitting the indication of the micro-Doppler measurements, an indication of a second AI/ML model that is an update of the first AI/ML model. Additionally, or alternatively, the communication manager 150 may perform one or more other operations described herein.

As indicated above, FIG. 1 is provided as an example. Other examples may differ from what is described with regard to FIG. 1.

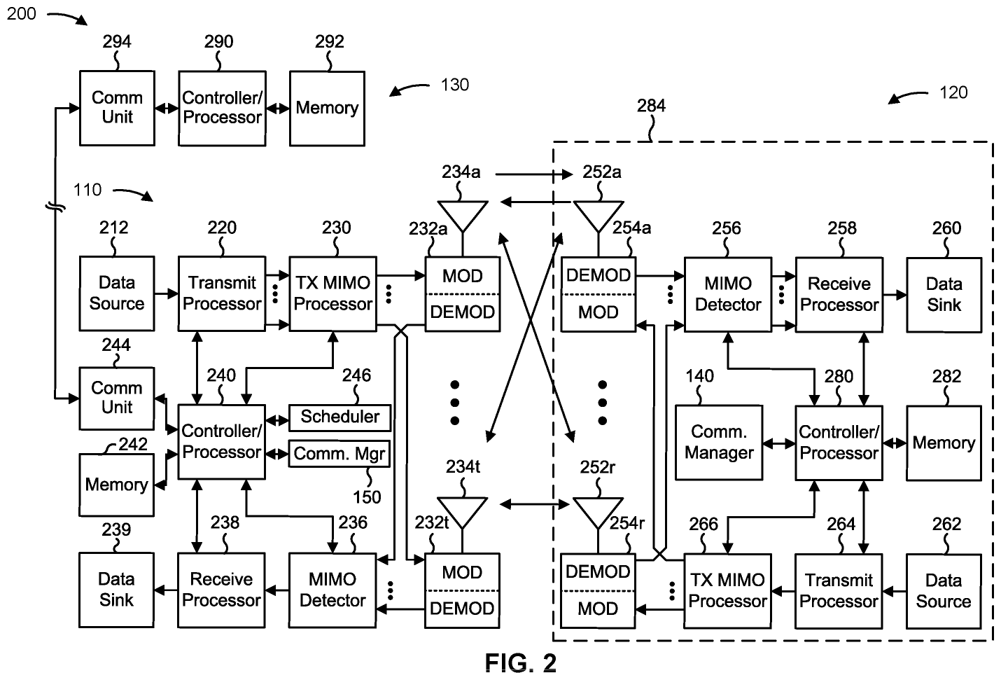

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

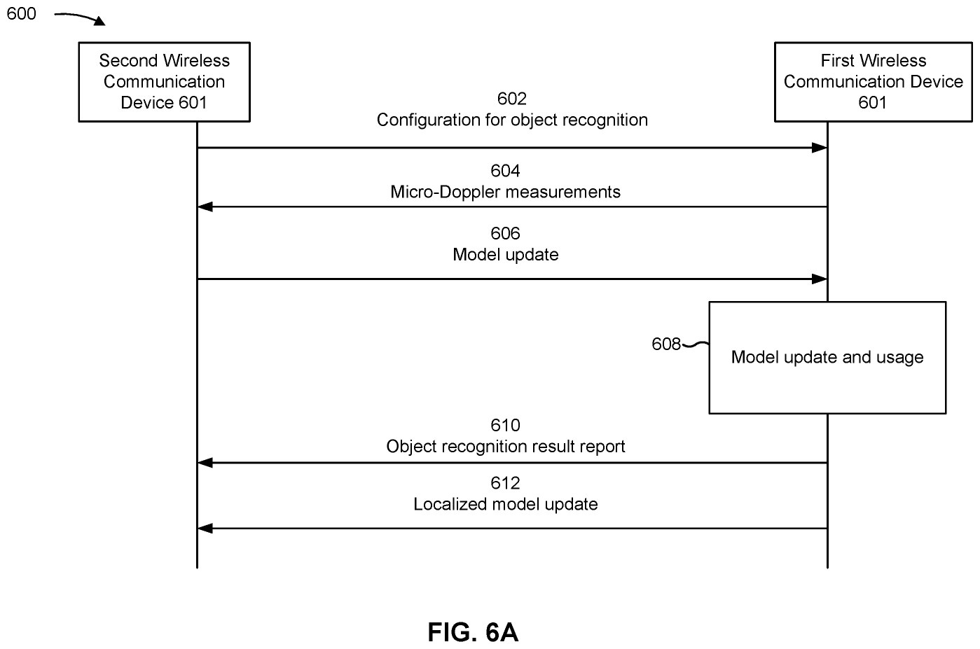

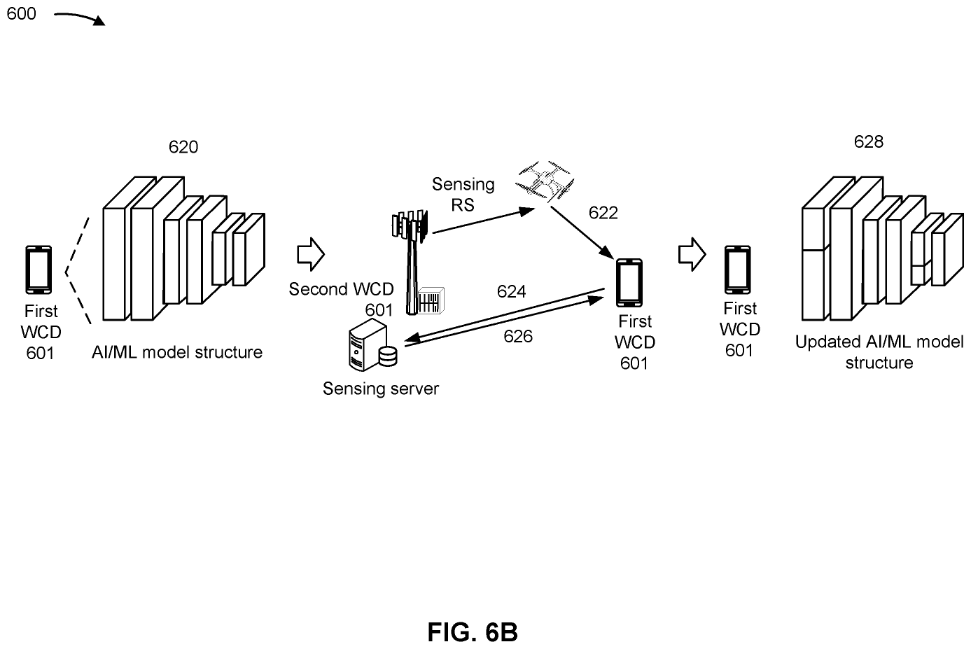

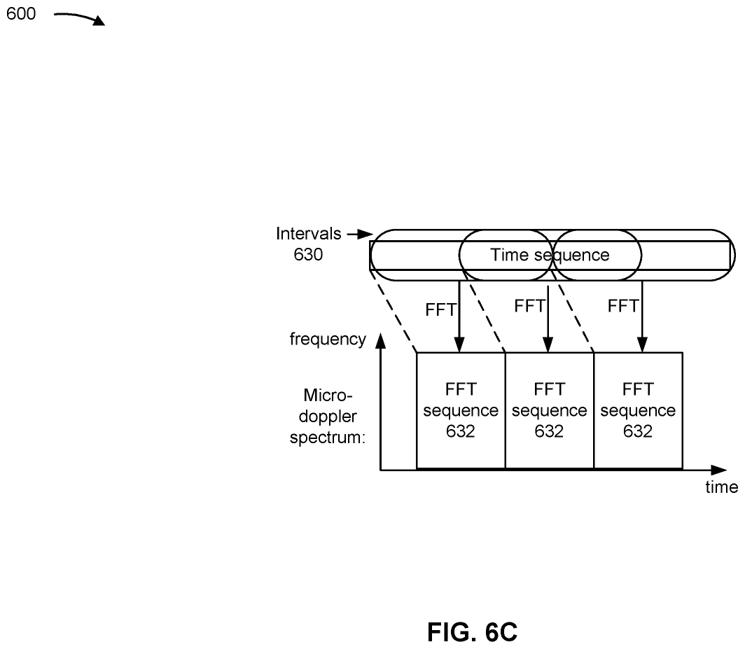

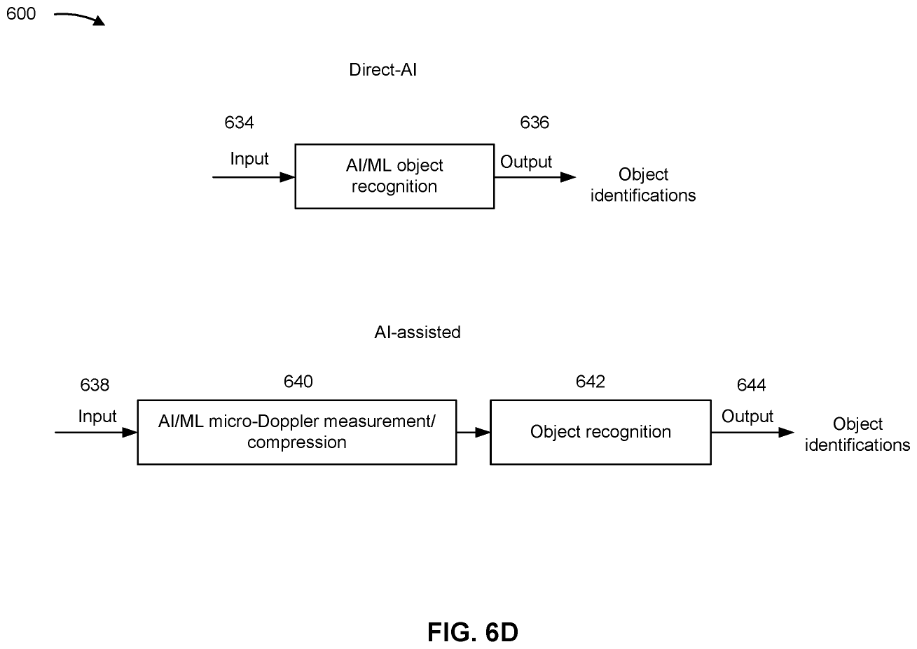

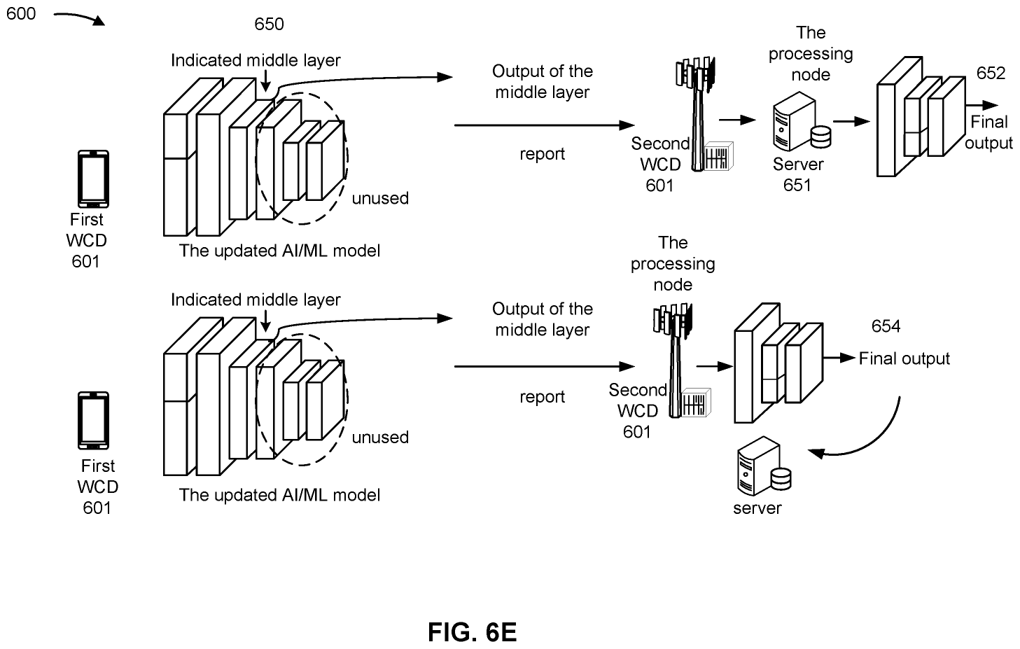

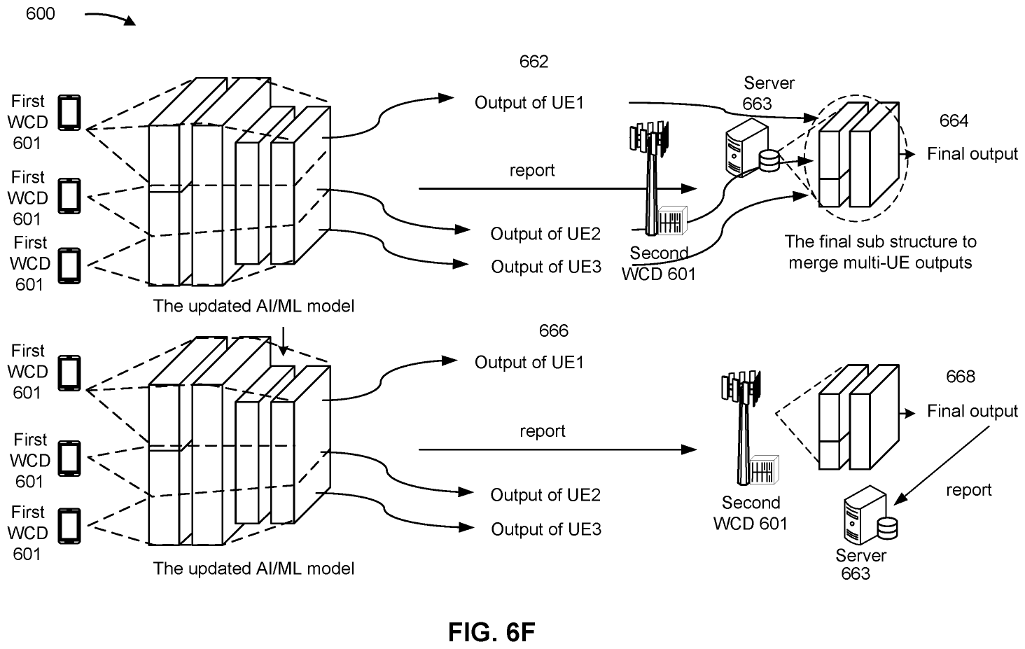

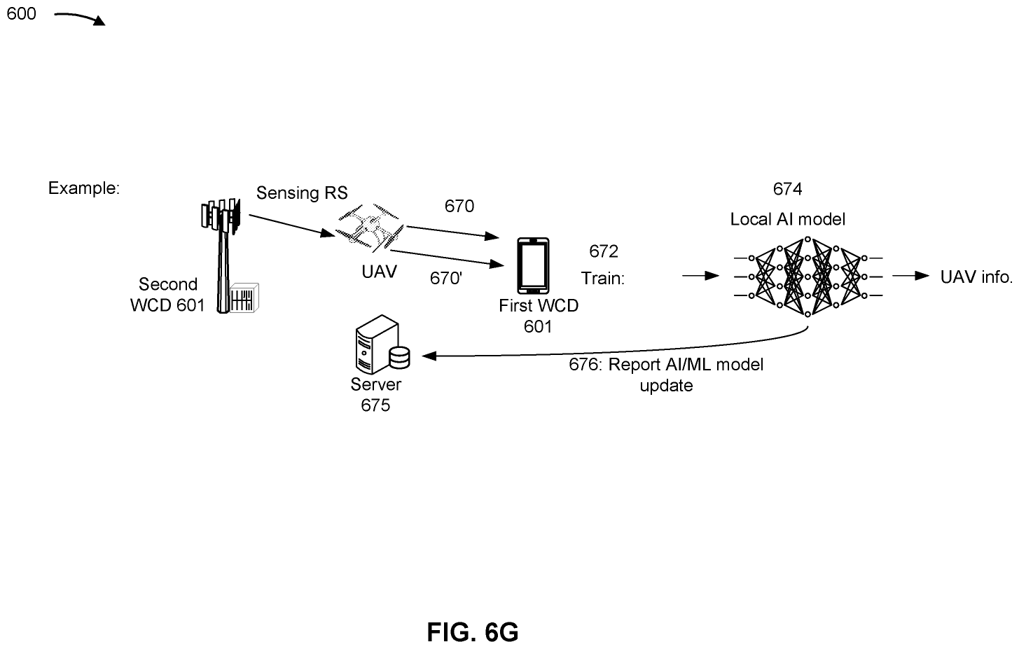

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6A-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6A-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

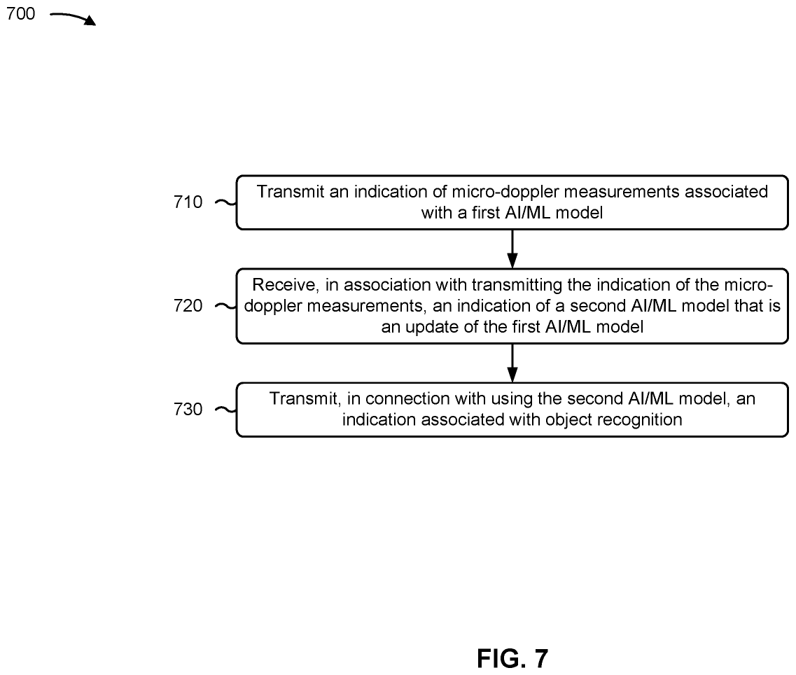

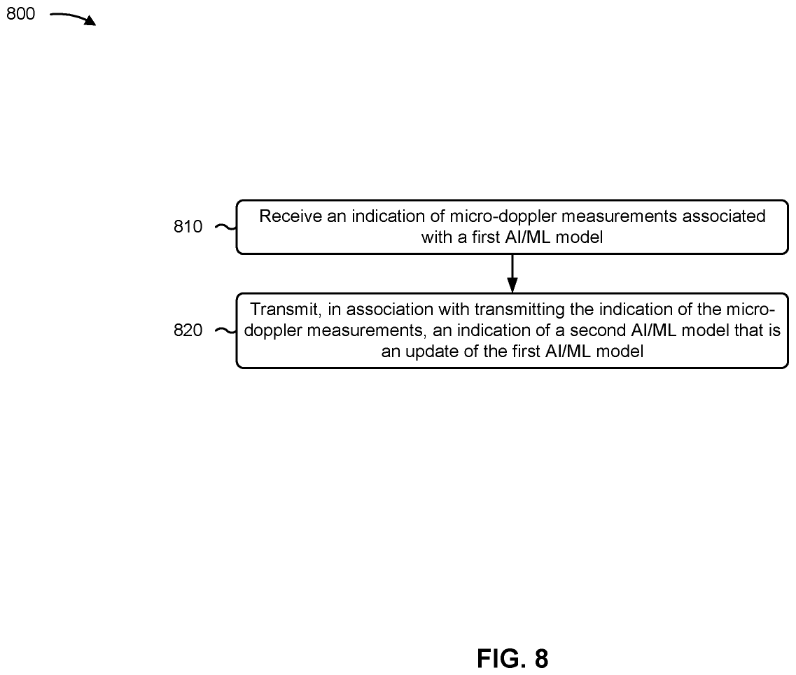

The controller/processor 240 of the network node 110, the controller/processor 280 of the UE 120, or any other component(s) of FIG. 2 may perform one or more techniques associated with updating an AI/ML model for object recognition, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a wireless communication device, such as a UE 120 or a UAV UE 120, includes means for transmitting an indication of micro-Doppler measurements associated with a first AI/ML model; means for receiving, in association with transmitting the indication of the micro-Doppler measurements, an indication of a second AI/ML model that is an update of the first AI/ML model; and/or means for transmitting, in connection with using the second AI/ML model, an indication associated with object recognition. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving an indication of micro-Doppler measurements associated with a first AI/ML model; and/or means for transmitting, in association with transmitting the indication of the micro-Doppler measurements, an indication of a second AI/ML model that is an update of the first AI/ML model. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

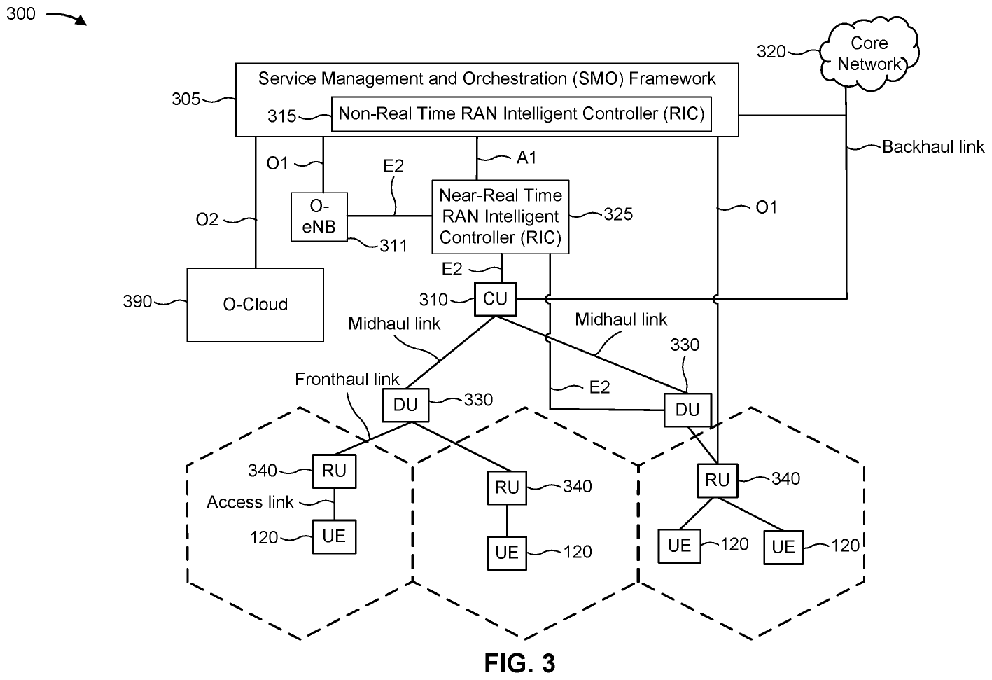

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

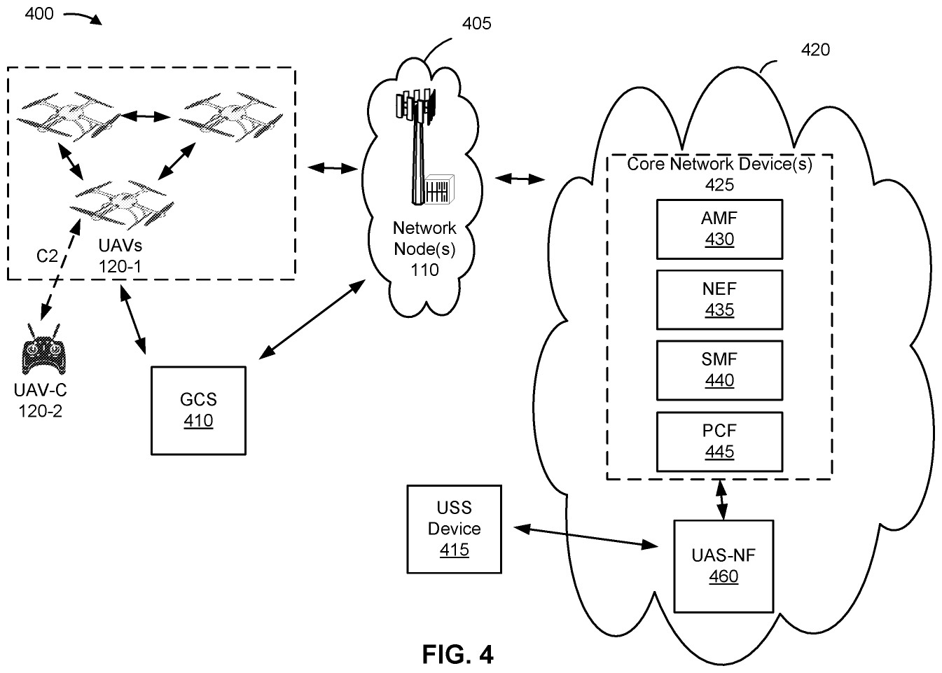

FIG. 4 is a diagram illustrating an example of UAV UEs 120 within a wireless communication network environment 400, in accordance with the present disclosure. As shown in FIG. 4, the environment 400 can include one or more UEs 120, which may include one or more UAVs 120-1 and one or more UAV controllers (UAV-Cs) 120-2, a RAN 405, a core network 420, a UAV service supplier (USS) device 415, and a ground control system (GCS) 410. Devices of environment 400 can interconnect via wired connections, wireless connections, or a combination of wired and wireless connections.

The UAV 120-1 (also referred to herein as a UAV UE 120-1) may include an aircraft without a human pilot aboard and can also be referred to as an unmanned aircraft (UA), a UAV, a remotely piloted vehicle (RPV), a remotely piloted aircraft (RPA), a remotely operated aircraft (ROA), or an uncrewed aerial vehicle. The UAV 120-1 may have a variety of shapes, sizes, configurations, characteristics, or the like for a variety of purposes and applications. In some examples, the UAV 120-1 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. In some examples, the UAV 120-1 may include one or more components for communicating with one or more network nodes 110. Additionally, or alternatively, the UAV 120-1 may transmit information to and/or receive information from the GCS 410, such as sensor data, flight plan information, or the like. Such information can be communicated directly (e.g., via an RRC signal and/or the like) and/or via the network node(s) 110 on the RAN 405. The UAV 120-1 may be a component of an unmanned aircraft system (UAS). The UAS may include the UAV 120-1, a UAV-C 120-2 (also referred to herein as a UAV-C UE 120-2), and a system of communication (such as wireless communication network environment 400 or another system of communication) between the UAV 120-1 and the UAV-C 120-2.

The RAN 405 may include one or more network nodes 110 that provide access for the UAV UEs 120 to the core network 420. For example, the RAN 405 may include one or more aggregated network nodes and/or one or more disaggregated network nodes (e.g., including one or more CUs, one or more DUs, and/or one or more RUs). The UAV 120-1 may communicate with the network nodes 110 via the Uu interface. For example, the UAV 120-1 may transmit communications to a network node 110 and/or receive communications from the network node 110 via the Uu interface. Such Uu connectivity may be used to support different applications for the UAV 120-1, such as video transmission from the UAV 120-1 or C2 communications for remote command and control of the UAV 120-1, among other examples.

The GCS 410 may include one or more devices capable of managing the UAV 120-1 and/or flight plans for the UAV 120-1. For example, the GCS 410 may include a server device, a desktop computer, a laptop computer, or a similar device. In some examples, the GCS 410 may communicate with one or more devices of the environment 400 (e.g., the UAV 120-1, the USS device 415, and/or the like) to receive information regarding flight plans for the UAV UEs 120-1 and/or to provide recommendations associated with such flight plans, as described elsewhere herein. In some examples, the GCS 410 may permit a user to control one or more of the UAVs 120-1 (e.g., via the UAV-C 120-2). Additionally, or alternatively, the GCS 410 can use a neural network and/or other artificial intelligence (AI) to control one or more of the UAVs 120-1. In some examples, the GCS 410 may be included in a data center, a cloud computing environment, a server farm, or the like, which may include multiple GCSs 410. While shown as being external from the core network 420 in FIG. 4, in some aspects, the GCS 410 may reside at least partially within the core network 420.

The USS device 415 includes one or more devices capable of receiving, storing, processing, and/or providing information associated with the UAV UEs 120 and/or the GCS 410. For example, the USS device 415 can include an application server, a desktop computer, a laptop computer, a tablet computer, a mobile phone, or a similar device. In some examples, the UAVs 120-1 can interact with the USS device 415 to register a flight plan, receive approval, analysis, and/or recommendations related to a flight plan, or the like. The USS device 415 may register the UAV UE 120 with the USS device 415 by assigning an application-level UAV identifier to the UAV UE 120. The application-level UAV identifier may be an aviation administration (e.g., a regulatory body that governs aviation operation in a jurisdiction in which the USS device 415 and the UAV UE 120 are operating) UAV identifier.

The core network 420 includes a network that enables communications between the RAN 405 (e.g., the network node(s) 110) and one or more devices and/or networks connected to the core network 420. For example, the core network 420 may be a 5G core network. The core network 420 may include one or more core network devices 425, such as one or more access and mobility management functions (AMFs) (herein after referred to as an “AMF”) 430, one or more network exposure functions (NEFs) (herein after referred to as an “NEF”) 435, one or more session management functions (SMFs) (herein after referred to as an “SMF”) 440, one or more policy control functions (PCFs) (herein after referred to as a “PCF”) 445, and/or other entities and/or functions that provide mobility functions for the UAV UEs 120 and enable the UAV UEs 120 to communicate with other devices of the environment 400.

The AMF 430 may include one or more network devices, such as one or more server devices, capable of managing authentication, activation, deactivation, and/or mobility functions associated with the UAV UE 120 connected to the core network 420. In some examples, the AMF 430 may perform operations relating to authentication of the UAV 120-1. The AMF 430 may maintain a non-access stratum (NAS) signaling connection with the UAV 120-1.

The NEF 435 may include one or more network exposure devices, such as one or more server devices, capable of exposing capabilities, events, information, or the like in one or more wireless networks to help other devices in the one or more wireless networks discover network services and/or utilize network resources efficiently. In some examples, the NEF 435 may receive traffic from and/or send traffic to the UAV 120-1 via the AMF 430 and the network node 110, and the NEF 435 may receive traffic from and/or send traffic to the USS device 415 via a UAS network function (UAS-NF) 460. In some examples, the NEF 435 may obtain a data structure, such as approval of a flight plan for the UAV 120-1, from the USS device 415 and divide the data structure into a plurality of data segments. In some examples, the NEF 435 may determine a location and/or reachability of the UAV 120-1 and/or a communication capability of the network node 110 to determine how to send the plurality of data segments to the UAV 120-1.

The SMF 440 may include one or more network devices, such as one or more server devices, capable of managing sessions for the RAN 405 and allocating addresses, such as Internet protocol (IP) addresses, to the UAVs 120-1. In some examples, the SMF 440 may perform operations relating to registration of the UAV 120-1. For example, the AMF 430 may receive a registration request from the UAV 120-1 and forward a request to the SMF 440 to create a corresponding packet data unit (PDU) session. The SMF 440 may allocate an address to the UAV 120-1 and establish the PDU session for the AMF 430.

The PCF 445 may include one or more network devices, such as one or more server devices, capable of managing traffic to and from the UAV UEs 120 through the RAN 405 and enforcing a QoS on the RAN 405. In some examples, the PCF 445 may implement charging rules and flow control rules, manage traffic priority, and/or manage a QoS for the UAVs 120-1.

The USS device 415 may communicate with the core network 420 using the UAS-NF 460. The UAS-NF 460 may be a service-based interface to enable the USS device 415 to provide information to the core network 420. For example, the USS device 415 may provide, via the UAS-NF 460, registration information associated with a registration between the UAV 120-1 and the USS device 415. The UAS-NF 460 may include a device, such as a server device, that is external to the core network 420, or the UAS-NF 460 may reside, at least partially, on a core network device 425 within the core network 420. In some aspects, the UAS-NF 460 may be co-located with the NEF 435. In some aspects, or more of the core network device(s) 425 and/or the UAS-NF 460 may correspond to network controller 130, as described above in connection with FIG. 1.

The UAV-C 120-2 may remotely control the UAV 120-2 by transmitting C2 communications to the UAV 120-1 and/or receiving C2 communications from the UAV 120-1. In some examples, the UAV-C 120-2 and the UAV 120-1 may use the Uu interface for the C2 communications. For example, the UAV-C 120-2 may transmit C2 communications to UAV 120-1 (and receive C2 communications from the UAV 120-1) via the network node 110. In some examples, the UAV-C 120-2 and the UAV 120-1 may use a non-cellular communication system (e.g., non-3GPP connectivity), such as wireless fidelity (Wi-Fi), for the C2 communications. Currently, NR, in the specification promulgated by 3GPP, does not support transmission of C2 communications via the PC5 interface. However, in some cases, the UAV-C 120-2 may be capable of communicating via the PC5 interface, but may not have Uu capability. Furthermore, because PC5 can cover a longer distance than Wi-Fi, transmission of C2 communications via PC5 unicast communications may result in an increased range of the C2 communications, as compared with Wi-Fi. In addition, transmission of C2 communications via PC5 unicast communications (e.g., via a PC5 direct link between the UAV 120-1 and the UAV-C 120-2) may result in decreased latency, as compared with C2 communications transmitted via the network node 110 using the Uu interface.

As indicated above, FIG. 4 is provided as an example. Other examples may differ from what is described with respect to FIG. 4.

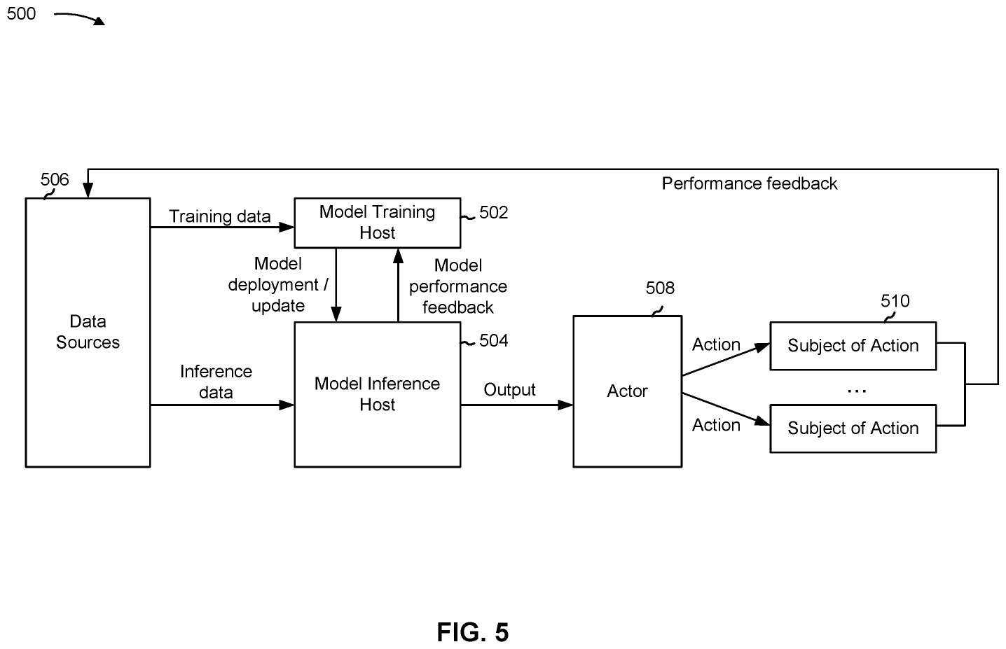

FIG. 5 is a diagram illustrating an example architecture 500 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with position determination, the actor 508 may be a UE, a DU or an RU. In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., an NR measurement), may input the measurement to the AI/ML model at the model inference host 504 (or may provide the measurement to the model inference host 504), and may act based on an output of the AI/ML model (e.g., an object recognition).

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. If the actor 508 determines to act based on the output, in some examples, the actor 508 may indicate the action to at least one subject of action 510.

The data sources 506 may also be configured for collecting data that is used as training data for training an ML model or as inference data for feeding an ML model inference operation. For example, the data sources 506 may collect data from one or more core network and/or RAN entities, which may include the actor 508 or the subject of action 510, and provide the collected data to the model training host 502 for ML model training. In some aspects, the model training host 502 may be co-located with the model inference host 504 and/or the actor 508. For example, the actor 508 or the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, the model training host 502 may monitor or evaluate ML model performance using a training position value, which may be provided by a node (e.g., a UE 120 or a network node 110), as described elsewhere herein. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

In some communications systems, AI/ML models may be deployed at different devices to perform determination or prediction tasks. For example, a UE may use an AI/ML model to predict a beam or a set of parameters of a beam that the UE is to use during a handover scenario. Similarly, a UE may use an AI/ML model for object recognition (e.g., using a camera of the UE). Some communications systems incorporate UAVs to perform tasks, such as providing coverage extension (e.g., as a repeater), performing monitoring (e.g., meteorological monitoring, environmental monitoring), low-altitude airspace and ground management (e.g., sensing of other UAVs, sensing of vehicles, sensing of pedestrians), mapping, intruder detection, or other use cases. Additionally, or alternatively, UAVs may perform gesture recognition, vital signal detection, high-resolution imaging, sensing assisted communication (e.g., beam management) or other tasks.

To avoid collisions and/or for other sensing tasks, some UAVs may perform object detection procedures. For example, a UAV may detect a presence of a bird, and may avoid the detected bird when moving between locations. Additionally, or alternatively, a UAV may identify and classify another UAV, which may enable collision avoidance, sensing coordination, airspace detection, or other tasks. One sensor type that a UAV may use to perform object detection is a camera sensor. For example, a UAV may use an AI/ML computer vision algorithm to detect a presence of a bird in imaging of a scene. Another sensor type that the UAV may use is a Doppler effect sensor. In this case, the UAV may detect a micro-Doppler effect and may process variations in an observed micro-Doppler effect to detect a rotor rotation of another UAV, a wing flapping of a bird, an arm motion of a walking pedestrian, or a wheel rotation of a vehicle. Additionally, or alternatively, the UAV may use micro-Doppler variations to detect characteristics of an object, such as a rotor size, a rotor number, a rotor velocity, or another characteristic of another UAV. Micro-Doppler effect sensing includes the processing of Doppler shifts detected from micro-scale movements (e.g., a micro-Doppler spectrum), using AI/ML models, to infer object detection or object characteristics.

However, a micro-Doppler spectrum processing may be resource intensive, which may prevent a sensing UAV from performing object detection tasks using an AI/ML model. Accordingly, the AI/ML model may be offloaded to another device, such as a UE and/or a network node. The UE and/or the network node may receive sensing measurements, generate a prediction (e.g., identify an object), and transmit an indication of the prediction, which enables the sensing UAV to, for example, avoid the identified object. As an example, the sensing UAV may control flight in a first manner to avoid another UAV and in a second manner to avoid a bird. However, conveying a micro-Doppler spectrum may be data intensive and may have a relatively large signaling overhead. It has been proposed to reduce the signaling overhead by having a UE perform a prediction locally and report a result of the prediction without communicating with a network node. However, a single, general AI/ML model deployed at the UE, to perform generalized predictions (e.g., a different levels of micro-Doppler features, for different types of sensing, etc.) may have a low level of accuracy. Further, deploying a plurality of models, at a UE, concurrently may result in excessive utilization of data storage at the UE.

Some aspects described herein enable updating AI/ML models for object detection. For example, a UE may receive micro-Doppler measurements and may request an AI/ML update of a first AI/ML model deployed at the UE. The request may include information regarding the micro-Doppler measurements, such as a level of granularity or confidence with the micro-Doppler measurements or a type of sensing that is to be performed (e.g., sensing of a classification of an object, such as a bird or UAV, or sensing of a characteristic of a particular type of object, such as a number of rotors of a UAV). The request may be less resource intensive than full AI/ML prediction offloading, thereby reducing signaling overhead. The UE may receive, from a network node, a response with an AI/ML update, which configures a second AI/ML model at the UE (e.g., an entirely new AI/ML model or an update or change of parameters of the first AI/ML model). The UE can use the second AI/ML model, which may have a higher level of accuracy than the first AI/ML model, and report a result of using the AI/ML model to the UAV.

In this way, the UE, the network node, and/or the UAV enable improved prediction (e.g., object recognition) for UAVs that are offloading predictions to another wireless communication device, such as to UEs. By improving prediction, the UE enables improved flight characteristics, improved completion of sensing tasks, and/or reduced likelihood of damage (e.g., resulting from collisions) relative to less accurate prediction.

FIGS. 6A-6G are diagrams illustrating an example 600 associated with updating AI/ML model for object recognition, in accordance with the present disclosure. As shown in FIG. 6A, example 600 includes communication between a first wireless communication device 601 and a second wireless communication device 601. The wireless communication devices 601 may correspond to network nodes 110, UEs 120, UAVs, or servers, among other examples.

As further shown in FIG. 6A, and by reference number 602, the second wireless communication device 601 may configure the first wireless communication device 601 (or another type of wireless communication device) for object recognition. For example, the second wireless communication device 601 may transmit configuration information identifying a first AI/ML model for object recognition using micro-Doppler measurements as input. In some aspects, the AI/ML model may be a neural network model for object recognition. In some aspects, the first wireless communication device 601 may receive configuration information identifying a trained first AI/ML model. For example, the first wireless communication device 601 may receive a set of weights, layers, or other parameters of the first AI/ML model. Additionally, or alternatively, the first wireless communication device 601 may receive training data from which to train the first AI/ML model. In this case, the first wireless communication device 601 may perform a training procedure to generate the set of weights, layers, or other parameters.

In some aspects, the first wireless communication device 601 (or a UAV associated therewith) may receive, from the second wireless communication device 601 (e.g., a controlling node) information indicating a set of parameters of a micro-Doppler measurement that is to be used as an AI/ML model input. For example, the first wireless communication device 601 (or a UAV associated therewith) may receive information indicating whether micro-Doppler spectrums are generated per path (e.g., a signal profile is extracted for each detected path to compute a micro-Doppler spectrum for each path) or for a plurality of paths (e.g., a combined signal profile of some or all paths is used to generate a micro-Doppler spectrum, which may include individual micro-Doppler patterns that overlap). Additionally, or alternatively, the first wireless communication device 601 (or a UAV associated therewith) may receive information identifying a set of characteristics, such as a minimum threshold value or a maximum threshold value, for a set of parameters, such as a delay parameter, a range parameter, a Doppler shift parameter, an angle parameter, a signal strength parameter, or a signal quality parameter (e.g., an RSRP, an RSRQ, an RSSI, a signal-to-noise ratio (SNR), or a signal-to-interference-and-noise ratio (SINR)), among other examples. In some aspects, the first wireless communication device 601 (or a UAV associated therewith) may receive respective indications for micro-Doppler measurements and updated AI/ML model inputs. In other words, the first wireless communication device 601 (or a UAV associated therewith) may receive a first indication of a minimum Doppler shift to report for a first set of micro-Doppler measurements used with the first AI/ML model and a second indication of a minimum Doppler shift to use as input for a second AI/ML model that is an update of the first AI/ML model.

In some aspects, the first wireless communication device 601 may receive configuration information from the second wireless communication device 601 via a particular signaling pathway. For example, when the first wireless communication device 601 is a UE, the first wireless communication device 601 may receive the configuration information via layer 1 (L1) downlink control information (DCI) signaling, layer 2 (L2) MAC control element (CE) (MAC-CE) signaling, or layer 3 (L3) RRC signaling. Additionally, or alternatively, when the first wireless communication device 601 is controlled by a core network device, the first wireless communication device 601 may receive configuration information via NAS or next generation (NG) application protocol (NGAP) signaling. When the second wireless communication device 601 is a controlling network node with a server (e.g., a location or sensing server, such as a location management function (LMF) or sensing management function (SnMF)), the first wireless communication device 601 may receive the configuration information via L3 signaling, such as RRC signaling conveying information elements (IEs) associated with LTE position protocol (LPP) or a dedicated sensing protocol. Additionally, or alternatively, the first wireless communication device 601 may receive configuration information via NR positioning protocol annex (NRPPa) protocol signaling. Additionally, or alternatively, the first wireless communication device 601 may receive (e.g., when a UE is configuring a UE) the configuration information via a sidelink message, such as a sidelink L1 message (e.g., a sidelink control information (SCI) physical sidelink control channel (PSCCH) message or a physical sidelink shared channel (PSSCH) data message), a sidelink L2 message (e.g., a MAC-CE), or a sidelink L3 message (e.g., RRC or PC5 signaling). Additionally, or alternatively, the first wireless communication device 601 may receive the configuration information via L1 uplink control information (UCI), L2 MAC-CE, or L3 RRC (e.g., when a UE is configuring a network node).

As further shown in FIG. 6A, and by reference number 604, the second wireless communication device 601 may receive information identifying a first set of micro-Doppler measurements. For example, the first wireless communication device 601 may receive, from a UAV, information identifying the set of micro-Doppler measurements, and the first wireless communication device 601 may transmit an indication of the set of micro-Doppler measurements to the second wireless communication device 601.

In some aspects, the first wireless communication device 601 may transmit, as the indication of the set of micro-Doppler measurements, an output of the first AI/ML model. For example, the first wireless communication device 601 may transmit a set of model outputs, which may include a compressed Doppler spectrum, a Doppler spread, or another parameter, as described herein. Additionally, or alternatively, the first wireless communication device 601 may transmit an indication of a confidence level associated with the micro-Doppler spectrum (or an output of the first AI/ML model). In this case, the confidence level may correspond to a signal strength or signal quality associated with the micro-Doppler measurements. In this case, when the micro-Doppler spectrum is associated with a relatively high confidence level, the second wireless communication device 601 may indicate a second AI/ML model that has a relatively small size or is trained using a dataset of relatively high quality micro-Doppler measurements. In contrast, when the micro-Doppler spectrum is associated with a relatively low confidence level, the second wireless communication device 601 may indicate a second AI/ML model that has a relatively large size or is trained using a dataset of relatively low quality micro-Doppler measurements (which may be appropriate to evaluate an actual micro-Doppler measurements associated with a low confidence level from the first AI/ML model).

In some aspects, the first wireless communication device 601 may transmit assistance information that the second wireless communication device 601 may use to select an update to the first AI/ML model to generate the second AI/ML model or transform the first AI/ML model to the second AI/ML model, as described herein. For example, the first wireless communication device 601 may indicate a maximum storage size for an AI/ML model, a set of suggested parameters, a set of sensing tasks that are to be performed, a set of requirements (e.g., an accuracy requirement for controlling the UAV or performing a meteorological prediction using data measured by, for example, the UAV).

As further shown in FIG. 6A, and by reference number 606, the second wireless communication device 601 may transmit information associated with updating the first AI/ML model. For example, the second wireless communication device 601 may transmit an update with an indication of a second AI/ML model. In some aspects, the second AI/ML model may be an alteration to the first AI/ML model. For example, the second wireless communication device 601 may transmit an indication of a change that the first wireless communication device 601 is to make to the first AI/ML model (e.g., a change to a weight, a change to a layer, etc.) to transform the first AI/ML model into the second AI/ML model, thereby updating the first AI/ML model. Additionally, or alternatively, the second AI/ML model may be a separate model from the first AI/ML model. In this case, the second wireless communication device 601 may transmit information identifying the second AI/ML model, such as information identifying a set of weights, layers, or other parameters of the second AI/ML model or training data from which the first wireless communication device 601 is to derive the second AI/ML model.

In some aspects, the second wireless communication device 601 may select one or more parameters for model updating in connection with information received from the first wireless communication device 601. For example, the second wireless communication device 601 may use the set of micro-Doppler measurements (or an indication associated therewith) and an indication of a sensing task to select a second AI/ML model to deploy at the first wireless communication device 601. In this case, the second wireless communication device 601 may compare the first AI/ML model and the second AI/ML model, determine a set of differences (e.g., parameter value differences, layer differences, configuration differences, etc.), and transmit an indication of the set of differences. Accordingly, the first wireless communication device 601 may use the set of differences to transform the first AI/ML model to generate an updated AI/ML model (e.g., the second AI/ML model). In some aspects, the set of differences may include information identifying a set of new weights, a set of neural network nodes, a weight and connection matrix, a position of a set of new layers, a convolution kernel (e.g., a kernel size, type, stride, or padding), a pooling method, or an activation function, among other examples.

In some aspects, the second wireless communication device 601 may configure an input format or an output format for an updated AI/ML model (e.g., the second AI/ML model). For example, for an input format, the second wireless communication device 601 may configure a set of parameters for a set of micro-Doppler spectrums, a computation method for the set of parameters, a sampling method for the set of parameters, a normalization method for the set of parameters, a size or scaling of the micro-Doppler spectrum, or a data processing technique (e.g., a covariance method), among other examples. In this case, the second wireless communication device 601 may transmit a control information message that includes a set of values or indices that the first wireless communication device 601 can interpret to determine the configured set of parameters. Similarly, for an output format, the second wireless communication device 601 may configure an output size or an output interpretation for each element of an output of the updated AI/ML model. In other words, the second wireless communication device 601 may configure the updated AI/ML model to output a vector of a given length of elements, with each element having a particular interpretation, such as a first element indicating whether a detected object has 4 rotors or 8 rotors, a second element indicating whether a detected object is greater than a threshold size or not, a third element indicating a yaw value, a fourth element indicating a pitch value, a fifth element indicating a roll value, or a sixth element indicating a quantization method or a set of other measurements, among other examples.

As further shown in FIG. 6A, and by reference number 608, the first wireless communication device 601 (or another type of wireless communication device) may update an AI/ML model and use an updated AI/ML model. For example, the first wireless communication device 601 may transform the first AI/ML model, using the update from the second wireless communication device 601, to generate or create the second AI/ML model. Additionally, or alternatively, the first wireless communication device 601 may replace the first AI/ML model with the second AI/ML model. The first wireless communication device 601 may use the updated AI/ML model (e.g., the second AI/ML model) to analyze micro-Doppler measurements. For example, the first wireless communication device 601 may convert a micro-Doppler spectrum into a usable input format (e.g., a format of one or more numerical values that can be input into the second AI/ML model) and may analyze the micro-Doppler spectrum using the updated AI/ML model.

In this case, the first wireless communication device 601 may obtain an output of the updated AI/ML model, which may include a prediction or determination of an object represented in the micro-Doppler spectrum (e.g., an object observed in one or more measurements that comprise the micro-Doppler spectrum) or a set of characteristics of the object. For example, as shown in FIG. 6B, the first wireless communication device 601 is configured with a first AI/ML model (at 620), receives a set of micro-Doppler measurements from a UAV (e.g., that senses a reference signal from the second wireless communication device 601) (at 622), reports an indication of the set of micro-Doppler measurements to the second wireless communication device 601 (at 624), receives an AI/ML update indication from the second wireless communication device 601 (at 626), and generates a second, updated AI/ML model that is used to perform object recognition (at 628). The set of micro-Doppler measurements may include, as shown in FIG. 6C, a set of time intervals 630, for which corresponding FFT sequences 632 are derived to characterize a movement observed during the time interval.

In some aspects, the first wireless communication device 601 may perform direct AI sensing and may report a final output of the updated AI/ML model. For example, as shown in FIG. 6D, the first wireless communication device 601 may input micro-Doppler measurements (e.g., a micro-Doppler spectrum) into the updated AI/ML model (at 634) and may output an object identification (e.g., an identification of an object or a characteristic thereof) (at 636). Additionally, or alternatively, the first wireless communication device 601 may perform AI assisted sensing. In AI assisted sensing, the first wireless communication device 601 uses the updated AI/ML model to perform a sub-task of the object identification process. In other words, the first wireless communication device 601 may input micro-Doppler measurements to the AI/ML model (at 638) and generate an output, such as a micro-Doppler pattern, a micro-Doppler period, a micro-Doppler path number, or a compressed micro-Doppler spectrum, among other examples (at 640). In this case, the first wireless communication device 601 may report the output of the AI/ML model to the second wireless communication device 601, which may perform object recognition for the first wireless communication device 601 using the output (at 642) and generate an output of the object recognition (at 644). For example, the second wireless communication device 601 may use a micro-Doppler pattern to perform an object recognition. In this case, use of the AI/ML model at the UE 120 enables a reduction of information (e.g., by using a compressed micro-Doppler spectrum) transmitted to the second wireless communication device 601 (e.g., relative to reporting unprocessed micro-Doppler measurements) and the object recognition performed at the second wireless communication device 601 enables improved accuracy (e.g., through greater resource availability at the second wireless communication device 601) or reduced resource utilization relative to performing object recognition at the UE 120.

In some aspects, the first wireless communication device 601 may report a middle layer output of the updated AI/ML model. For example, the first wireless communication device 601 may report a quantity, feature, or parameter, such as an index of a middle layer of the updated AI/ML model to the second wireless communication device 601. In this case, the second wireless communication device 601 may determine to forgo updating the AI/ML model after a middle layer of the AI/ML model (e.g., in a hierarchy of layers of the AI/ML model, the second wireless communication device 601 may update layers before the identified middle layer, but not after the identified middle layer). In some aspects, the second wireless communication device 601 may receive the middle layer output and may process the middle layer output (e.g., using an AI/ML model of the second wireless communication device 601) and provide a result of processing the middle layer output. For example, as shown in FIG. 6E, the first wireless communication device 601 reports an indication of a middle layer of the updated AI/ML model (at 650) to the second wireless communication device 601, which passes the indication of the middle layer, transparently, to a server 651 that generates a final output (e.g., an object recognition) (at 652). In another configuration, the second wireless communication device 601 (e.g., an integrated sensing and communication (ISAC) gNB) generates the final output and reports the final output to the server 651 (at 654), which is external to the second wireless communication device 601, for further processing, logging, or feedback generation for the first wireless communication device 601.

In some aspects, the first wireless communication device 601 may report an output of a sub-structure of the updated AI/ML model. For example, the first wireless communication device 601 may transmit a report of the output of the sub-structure of the AI model to the second wireless communication device 601 (e.g., for processing at the second wireless communication device 601 or for the second wireless communication device 601 to transparently pass the output to a server for processing, as described herein). In this case, an AI/ML model may have a plurality of sub-structures with each sub-structure being configured to process a micro-Doppler measurement for a corresponding wireless communication device. Accordingly, the first wireless communication device 601 may use a corresponding sub-structure, which is the updated AI/ML model of the first wireless communication device 601, and report an output of the corresponding sub-structure to the second wireless communication device 601 for further processing (e.g., with other outputs of other sub-structures of other wireless communication devices). As shown in FIG. 6F, a plurality of wireless communication devices report outputs to a second wireless communication device 601 (e.g., a controlling node) (at 662), which passes the outputs to a server 663 for processing. In this case, the server 663 uses a final sub-structure to merge the plurality of outputs and generate a single final output (at 664) (e.g., a single object recognition of an object observed by the plurality of wireless communication devices). In another example, the plurality of wireless communication devices report outputs to a second wireless communication device 601 (e.g., a processing node) (at 666), which generates the single final output and reports the single final output (at 668) to the server 663.

As further shown in FIG. 6A, and by reference number 610, the first wireless communication device 601 may transmit an object recognition report. For example, the first wireless communication device 601 may transmit information identifying a result of using the updated (second) AI/ML model, such as an output of the updated AI/ML model or processed object recognition results using the output of the updated AI/ML model, among other examples. Additionally, or alternatively, the first wireless communication device 601 may transmit another output of an AI/ML model, as described above, to enable the second wireless communication device 601 to perform an object recognition using the output and report the object recognition to the first wireless communication device 601. In some aspects, the first wireless communication device 601 may include a request for further sensing based on an output of the AI model. For example, when the output of the AI model indicates a detection of a UAV, the first wireless communication device 601 may request that additional sensing be performed to identify one or more characteristics of the UAV, such as a quantity of rotors or a size, among other examples.

In some aspects, the first wireless communication device 601 may transmit a report via a particular communication channel. For example, the first wireless communication device 601 may transmit the object recognition report via L1 UCI or uplink data, L2 MAC-CE, or L3 RRC signaling (e.g., when a UE is reporting to a network node). Additionally, or alternatively, the first wireless communication device 601 may transmit the object recognition report via a core network function message (e.g., NAS or NGAP signaling). Additionally, or alternatively, the first wireless communication device 601 may transmit the object recognition report via L3 signaling of an LPP protocol, NRPPa protocol, or a dedicated sensing protocol. Additionally, or alternatively, the first wireless communication device 601 may transmit the object recognition report via a sidelink channel or a downlink channel, as described above.

As further shown in FIG. 6A, and by reference number 612, the first wireless communication device 601 may transmit a model update to the second wireless communication device 601. For example, the first wireless communication device 601 may perform a local training procedure using known object information to generate a localized AI/ML model. The localized AI/ML model, which may be a third AI/ML model, may be transferred to the second wireless communication device 601 in connection with a federated learning procedure, in which the second wireless communication device 601 collects a plurality of localized AI/ML models from a plurality of sources (e.g., a plurality of UEs 120 or other wireless communication devices). The second wireless communication device 601 may use the federated learning procedure to improve AI/ML model based object recognition (e.g., by enabling the second wireless communication device 601 to transmit subsequent parameters, as described above, that result in more accurate updated AI/ML models than is achieved without federated learning).

For example, as shown in FIG. 6G, the first wireless communication device 601 receives a set of parameters of UAV information (e.g., a rotor number, a rotor rotation speed, or a rotor size) from a UAV (at 670) and also measures a set of micro-Doppler measurements with a sensing reference signal reflected by the UAV (at 670′), the first wireless communication device 601 may use the sets of parameters and micro-Doppler measurements to train a localized AI/ML model (at 672). The first wireless communication device 601 may use the localized AI/ML model for object recognition predictions (at 674) and may report information regarding the localized AI/ML model (e.g., a set of updated parameters, a training data type, or a sensing task) to a server 675 to enable the server 675 to update one or more other AI/ML models (at 676). In some aspects, the first wireless communication device 601 may train the localized AI/ML model using object information, such as outputs, labels, or synchronous measurements, among other examples, as inputs or data for supervised learning. For example, the first wireless communication device 601 may request a training configuration from the second wireless communication device 601, such as a K-fold cross validation, a learning rate, a maximum epoch number, a batch size, whether to use label smoothing, a type of data augmentation method, or another configuration parameter to use in generating a localized AI/ML model.

As indicated above, FIG. 6A is provided as an example. Other examples may differ from what is described with respect to FIG. 6A.

FIG. 7 is a diagram illustrating an example process 700 performed, for example, at a wireless communication device or an apparatus of a wireless communication device, in accordance with the present disclosure. Example process 700 is an example where the apparatus or the wireless communication device (e.g., the first wireless communication device 601, the UE 120, or the network node 110) performs operations associated with updating an AI/ML model for object recognition.

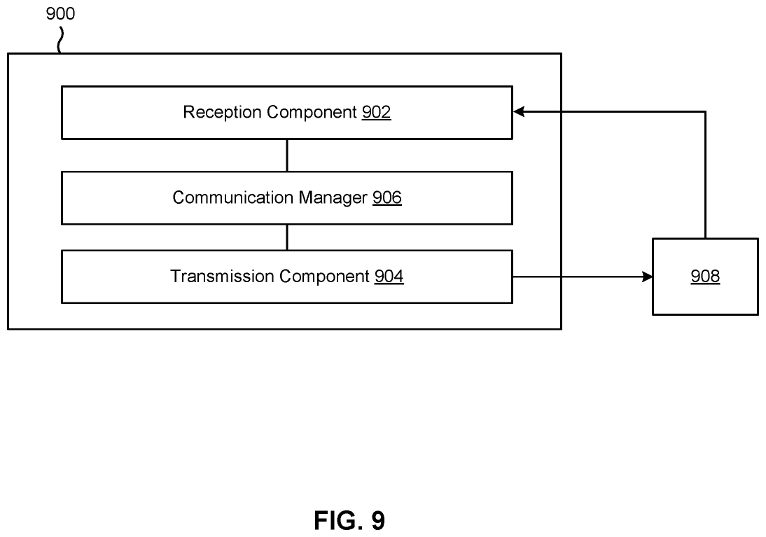

As shown in FIG. 7, in some aspects, process 700 may include transmitting an indication of micro-Doppler measurements associated with a first AI/ML model (block 710). For example, the wireless communication device (e.g., using transmission component 904 and/or communication manager 906, depicted in FIG. 9) may transmit an indication of micro-Doppler measurements associated with a first AI/ML model, as described above. In some aspects, the operation of block 710 may be performed by the transmission component 904 of FIG. 9.

As further shown in FIG. 7, in some aspects, process 700 may include receiving, in association with transmitting the indication of the micro-Doppler measurements, an indication of a second AI/ML model that is an update of the first AI/ML model (block 720). For example, the wireless communication device (e.g., using reception component 902 and/or communication manager 906, depicted in FIG. 9) may receive, in association with transmitting the indication of the micro-Doppler measurements, an indication of a second AI/ML model that is an update of the first AI/ML model, as described above. In some aspects, the operation of block 720 may be performed by the reception component 902 of FIG. 9.

As further shown in FIG. 7, in some aspects, process 700 may include transmitting, in connection with using the second AI/ML model, an indication associated with object recognition (block 730). For example, the wireless communication device (e.g., using transmission component 904 and/or communication manager 906, depicted in FIG. 9) may transmit, in connection with using the second AI/ML model, an indication associated with object recognition, as described above. In some aspects, the operation of block 730 may be performed by the transmission component 904 of FIG. 9.

Process 700 may include additional aspects, such as any single aspect or any combination of aspects described below and/or in connection with one or more other processes described elsewhere herein.

In a first aspect, the first AI/ML model is associated with object recognition.

In a second aspect, alone or in combination with the first aspect, the indication of the second AI/ML model comprises one or more of an indication of one or more of an input format or an output format, an indication of weights applicable to nodes of the AI/ML model, an indication of one or more layers to add to the AI/ML model, an indication of one or more parameters of the one or more layers to add, an indication of an update to a convolution kernel, an indication of a pooling operation, or an indication of an activation function.

In a third aspect, alone or in combination with one or more of the first and second aspects, the indication associated with the object recognition comprises one or more of an indication of a recognized object, an indication of measurements associated with the second AI/ML model, or an indication of a substructure of the second AI/ML model.

In a fourth aspect, alone or in combination with one or more of the first through third aspects, the measurements associated with the second AI/ML models may include an intermediate layer of AI/ML model-based object recognition to be completed by a network node.

In a fifth aspect, alone or in combination with one or more of the first through fourth aspects, the network node comprises an additional wireless communication device or a computing device.

In a sixth aspect, alone or in combination with one or more of the first through fifth aspects, the indication of the update to the first AI/ML models comprises one or more of an update to the substructure, or an indication of a position of the substructure within the AI/ML model.

In a seventh aspect, alone or in combination with one or more of the first through sixth aspects, process 700 includes transmitting an indication of a third AI/ML model, the third AI/ML model being an update to the second AI/ML model, in association with local model training at the wireless communication device.

In an eighth aspect, alone or in combination with one or more of the first through seventh aspects, the indication of the third AI/ML model comprises an indication of one or more parameters of the third AI/ML model, the third AI/ML model being associated with an identified object or one or more parameters of the identified object.

In a ninth aspect, alone or in combination with one or more of the first through eighth aspects, one or more of the first AI/ML model or the second AI/ML model is associated with one or more of one or more supported micro-Doppler spectra, a supported number of paths associated with the one or more supported micro-Doppler spectra, or a threshold of one or more of supported delay spreads, Doppler shifts, angles of arrival, or signal strengths.

In a tenth aspect, alone or in combination with one or more of the first through ninth aspects, the micro-Doppler measurements comprise one or more of an indication of a recognized object, an indication of a measurements associated with the first AI/ML model, or an indication of a confidence of the first AI/ML model for object recognition.

In an eleventh aspect, alone or in combination with one or more of the first through tenth aspects, the indication of the update to the first AI/ML model comprises an amount of updating that is associated with the confidence of the first AI/ML model for object recognition.

In a twelfth aspect, alone or in combination with one or more of the first through eleventh aspects, process 700 includes transmitting one or more of an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.

In a thirteenth aspect, alone or in combination with one or more of the first through twelfth aspects, the object recognition is based at least in part on updated micro-Doppler measurements that are updated relative to the micro-Doppler measurements based at least in part on a format for input to the second AI/ML model.

In a fourteenth aspect, alone or in combination with one or more of the first through thirteenth aspects, process 700 includes identifying a recognized object in association with an output of the second AI/ML model.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a wireless communication device, in accordance with the present disclosure. Example process 800 is an example where the apparatus or the wireless communication device (e.g., the second wireless communication device 601, the network node 110, or the UE 120) performs operations associated with updating an artificial intelligence or machine learning model for object recognition.

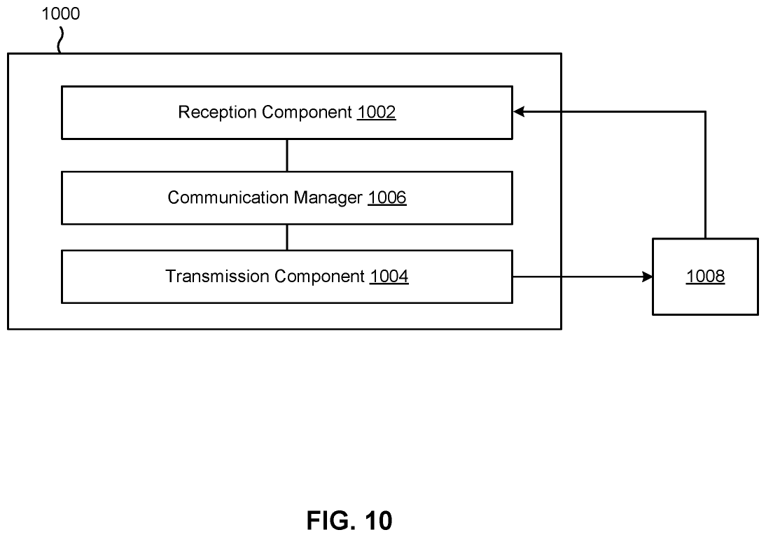

As shown in FIG. 8, in some aspects, process 800 may include receiving an indication of micro-Doppler measurements associated with a first AI/ML model (block 810). For example, the wireless communication device (e.g., using reception component 1002 and/or communication manager 1006, depicted in FIG. 10) may receive an indication of micro-Doppler measurements associated with a first AI/ML model, as described above. In some aspects, the operation of block 810 may be performed by the reception component 1002 of FIG. 10.

As further shown in FIG. 8, in some aspects, process 800 may include transmitting, in association with transmitting the indication of the micro-Doppler measurements, an indication of a second AI/ML model that is an update of the first AI/ML model (block 820). For example, the wireless communication device (e.g., using transmission component 1004 and/or communication manager 1006, depicted in FIG. 10) may transmit, in association with transmitting the indication of the micro-Doppler measurements, an indication of a second AI/ML model that is an update of the first AI/ML model, as described above. In some aspects, the operation of block 820 may be performed by the reception component 1002 of FIG. 10.

Process 800 may include additional aspects, such as any single aspect or any combination of aspects described below and/or in connection with one or more other processes described elsewhere herein.

In a first aspect, process 800 includes receiving, in connection with use of the second AI/ML model, an indication associated with object recognition.

In a second aspect, alone or in combination with the first aspect, the first AI/ML model is associated with object recognition.

In a third aspect, alone or in combination with one or more of the first and second aspects, the indication of the second AI/ML model comprises one or more of an indication of one or more of an input format or an output format, an indication of weights applicable to nodes of the AI/ML model, an indication of one or more layers to add to the AI/ML model, an indication of one or more parameters of the one or more layers to add, an indication of an update to a convolution kernel, an indication of a pooling operation, or an indication of an activation function.

In a fourth aspect, alone or in combination with one or more of the first through third aspects, the indication associated with the object recognition comprises one or more of an indication of a recognized object, an indication of measurements associated with the second AI/ML model, or an indication of a substructure of the second AI/ML model.

In a fifth aspect, alone or in combination with one or more of the first through fourth aspects, the measurements associated with the second AI/ML models may include an intermediate layer of AI/ML model-based object recognition to be completed by the wireless communication device.

In a sixth aspect, alone or in combination with one or more of the first through fifth aspects, the indication of the update to the first AI/ML models comprises one or more of an update to the substructure, or an indication of a position of the substructure within the AI/ML model.

In a seventh aspect, alone or in combination with one or more of the first through sixth aspects, process 800 includes receiving an indication of a third AI/ML model, the third AI/ML model being an update to the second AI/ML model, in association with local model training at a wireless communication device.

In an eighth aspect, alone or in combination with one or more of the first through seventh aspects, the indication of the third AI/ML model comprises an indication of one or more parameters of the third AI/ML model, the third AI/ML model being associated with an identified object or one or more parameters of the identified object.

In a ninth aspect, alone or in combination with one or more of the first through eighth aspects, one or more of the first AI/ML model or the second AI/ML model is associated with one or more of one or more supported micro-Doppler spectra, a supported number of paths associated with the one or more supported micro-Doppler spectra, or a threshold of one or more of supported delay spreads, Doppler shifts, angles of arrival, or signal strengths.

In a tenth aspect, alone or in combination with one or more of the first through ninth aspects, the micro-Doppler measurements comprise one or more of a n indication of a recognized object, an indication of a measurements associated with the first AI/ML model, or an indication of a confidence of the first AI/ML model for object recognition.

In an eleventh aspect, alone or in combination with one or more of the first through tenth aspects, the indication of the update to the first AI/ML model comprises an amount of updating that is associated with the confidence of the first AI/ML model for object recognition.

In a twelfth aspect, alone or in combination with one or more of the first through eleventh aspects, process 800 includes receiving one or more of an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.

In a thirteenth aspect, alone or in combination with one or more of the first through twelfth aspects, the object recognition is based at least in part on updated micro-Doppler measurements that are updated relative to the micro-Doppler measurements based at least in part on a format for input to the second AI/ML model.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a wireless communication device, or a wireless communication device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 of the UE 120 or the communication manager 150 of the network node 110, described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6A-6G. Additionally, or alternatively, the apparatus 900 may be configured to perform one or more processes described herein, such as process 700 of FIG. 7. In some aspects, the apparatus 900 and/or one or more components shown in FIG. 9 may include one or more components of the wireless communication device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the wireless communication device described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the wireless communication device described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an indication of micro-Doppler measurements associated with a first AI/ML model. The reception component 902 may receive, in association with transmitting the indication of the micro-Doppler measurements, an indication of a second AI/ML model that is an update of the first AI/ML model. The transmission component 904 may transmit, in connection with using the second AI/ML model, an indication associated with object recognition.

The transmission component 904 may transmit an indication of a third AI/ML model, the third AI/ML model being an update to the second AI/ML model, in association with local model training at the wireless communication device.

The transmission component 904 may transmit one or more of an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a wireless communication device, or a wireless communication device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 or the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6A-6G. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node or the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node or the UE described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node or the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an indication of micro-Doppler measurements associated with a first AI/ML model. The transmission component 1004 may transmit, in association with transmitting the indication of the micro-Doppler measurements, an indication of a second AI/ML model that is an update of the first AI/ML model.

The reception component 1002 may receive, in connection with use of the second AI/ML model, an indication associated with object recognition.

The reception component 1002 may receive an indication of a third AI/ML model, the third AI/ML model being an update to the second AI/ML model, in association with local model training at a wireless communication device.

The reception component 1002 may receive one or more of an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a wireless communication device, comprising: transmitting an indication of micro-Doppler measurements associated with a first artificial intelligence or machine learning (AI/ML) model; receiving, in association with transmitting the indication of the micro-Doppler measurements, an indication of a second AI/ML model that is an update of the first AI/ML model; and transmitting, in connection with using the second AI/ML model, an indication associated with object recognition.
Aspect 2: The method of Aspect 1, wherein the first AI/ML model is associated with object recognition.
Aspect 3: The method of any of Aspects 1-2, the object recognition is based at least in part on updated micro-Doppler measurements that are updated relative to the micro-Doppler measurements based at least in part on a format for input to the second AI/ML model.
Aspect 4: The method of any of Aspects 1-3, wherein the indication of the second AI/ML model comprises one or more of: an indication of one or more of an input format or an output format, an indication of weights applicable to nodes of the AI/ML model, an indication of one or more layers to add to the AI/ML model, an indication of one or more parameters of the one or more layers to add, an indication of an update to a convolution kernel, an indication of a pooling operation, or an indication of an activation function.
Aspect 5: The method of any of Aspects 1-4, wherein the indication associated with the object recognition comprises one or more of: an indication of a recognized object, an indication of measurements associated with the second AI/ML model, or an indication of a substructure of the second AI/ML model.
Aspect 6: The method of Aspect 5, wherein the measurements associated with the second AI/ML models may include an intermediate layer of AI/ML model-based object recognition to be completed by a network node.
Aspect 7: The method of Aspect 6, wherein the network node comprises an additional wireless communication device or a computing device.
Aspect 8: The method of Aspect 5, wherein the indication of the update to the first AI/ML models comprises one or more of: an update to the substructure, or an indication of a position of the substructure within the AI/ML model.
Aspect 9: The method of any of Aspects 1-8, further comprising: identifying a recognized object in association with an output of the second AI/ML model.
Aspect 10: The method of any of Aspects 1-9, further comprising: transmitting an indication of a third AI/ML model, the third AI/ML model being an update to the second AI/ML model, in association with local model training at the wireless communication device.
Aspect 11: The method of Aspect 10, wherein the indication of the third AI/ML model comprises: an indication of one or more parameters of the third AI/ML model, the third AI/ML model being associated with an identified object or one or more parameters of the identified object.
Aspect 12: The method of any of Aspects 1-11, wherein one or more of the first AI/ML model or the second AI/ML model is associated with one or more of: one or more supported micro-Doppler spectra, a supported number of paths associated with the one or more supported micro-Doppler spectra, or a threshold of one or more of supported delay spreads, Doppler shifts, angles of arrival, or signal strengths.
Aspect 13: The method of any of Aspects 1-12, wherein the micro-Doppler measurements comprise one or more of: a n indication of a recognized object, an indication of a measurements associated with the first AI/ML model, or an indication of a confidence of the first AI/ML model for object recognition.
Aspect 14: The method of Aspect 13, wherein the indication of the update to the first AI/ML model comprises an amount of updating that is associated with the confidence of the first AI/ML model for object recognition.
Aspect 15: The method of any of Aspects 1-14, further comprising transmitting one or more of: an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.
Aspect 16: A method of wireless communication performed by a wireless communication device, comprising: receiving an indication of micro-Doppler measurements associated with a first artificial intelligence or machine learning (AI/ML) model; and transmitting, in association with transmitting the indication of the micro-Doppler measurements, an indication of a second AI/ML model that is an update of the first AI/ML model.
Aspect 17: The method of Aspect 16, further comprising: receiving, in connection with use of the second AI/ML model, an indication associated with object recognition.
Aspect 18: The method of any of Aspects 16-17, wherein the first AI/ML model is associated with object recognition.
Aspect 19: The method of any of Aspects 16-18, the object recognition is based at least in part on updated micro-Doppler measurements that are updated relative to the micro-Doppler measurements based at least in part on a format for input to the second AI/ML model.
Aspect 20: The method of any of Aspects 16-19, wherein the indication of the second AI/ML model comprises one or more of: an indication of one or more of an input format or an output format, an indication of weights applicable to nodes of the AI/ML model, an indication of one or more layers to add to the AI/ML model, an indication of one or more parameters of the one or more layers to add, an indication of an update to a convolution kernel, an indication of a pooling operation, or an indication of an activation function.
Aspect 21: The method of any of Aspects 16-20, wherein the indication associated with the object recognition comprises one or more of: an indication of a recognized object, an indication of measurements associated with the second AI/ML model, or an indication of a substructure of the second AI/ML model.
Aspect 22: The method of Aspect 21, wherein the measurements associated with the second AI/ML models may include an intermediate layer of AI/ML model-based object recognition to be completed by the network node.
Aspect 23: The method of Aspect 21, wherein the indication of the update to the first AI/ML models comprises one or more of: an update to the substructure, or an indication of a position of the substructure within the AI/ML model.
Aspect 24: The method of any of Aspects 16-23, further comprising: receiving an indication of a third AI/ML model, the third AI/ML model being an update to the second AI/ML model, in association with local model training at a wireless communication device.
Aspect 25: The method of Aspect 24, wherein the indication of the third AI/ML model comprises: an indication of one or more parameters of the third AI/ML model, the third AI/ML model being associated with an identified object or one or more parameters of the identified object.
Aspect 26: The method of any of Aspects 16-25, wherein one or more of the first AI/ML model or the second AI/ML model is associated with one or more of: one or more supported micro-Doppler spectra, a supported number of paths associated with the one or more supported micro-Doppler spectra, or a threshold of one or more of supported delay spreads, Doppler shifts, angles of arrival, or signal strengths.
Aspect 27: The method of any of Aspects 16-26, wherein the micro-Doppler measurements comprise one or more of: a n indication of a recognized object, an indication of a measurements associated with the first AI/ML model, or an indication of a confidence of the first AI/ML model for object recognition.
Aspect 28: The method of Aspect 27, wherein the indication of the update to the first AI/ML model comprises an amount of updating that is associated with the confidence of the first AI/ML model for object recognition.
Aspect 29: The method of any of Aspects 16-28, further comprising receiving one or more of: an indication of available storage for the second AI/ML model, an indication of identified portions of the first AI/ML model for updating, an indication of one or more parameters of the object recognition, an indication of a request for further sensing in association with an output of the first AI/ML model or the second AI/ML model.
Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-29.
Aspect 31: An apparatus for wireless communication at a device, the apparatus comprising one or more memories and one or more processors coupled to the one or more memories, the one or more processors configured to cause the device to perform the method of one or more of Aspects 1-29.
Aspect 32: An apparatus for wireless communication, the apparatus comprising at least one means for performing the method of one or more of Aspects 1-29.
Aspect 33: A non-transitory computer-readable medium storing code for wireless communication, the code comprising instructions executable by one or more processors to perform the method of one or more of Aspects 1-29.
Aspect 34: A non-transitory computer-readable medium storing a set of instructions for wireless communication, the set of instructions comprising one or more instructions that, when executed by one or more processors of a device, cause the device to perform the method of one or more of Aspects 1-29.
Aspect 35: A device for wireless communication, the device comprising a processing system that includes one or more processors and one or more memories coupled with the one or more processors, the processing system configured to cause the device to perform the method of one or more of Aspects 1-29.
Aspect 36: An apparatus for wireless communication at a device, the apparatus comprising one or more memories and one or more processors coupled to the one or more memories, the one or more processors individually or collectively configured to cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A wireless communication device for wireless communication, comprising:
one or more memories; and
one or more processors, coupled to the one or more memories, configured to cause the wireless communication device to:
transmit an indication of micro-Doppler measurements associated with a first artificial intelligence or machine learning (AI/ML) model;
receive, in association with transmitting the indication of the micro-Doppler measurements, an indication of a second AI/ML model that is an update of the first AI/ML model; and
transmit, in connection with using the second AI/ML model, an indication associated with object recognition.

2. The wireless communication device of claim 1, wherein the first AI/ML model is associated with object recognition.

3. The wireless communication device of claim 1, the object recognition is based at least in part on updated micro-Doppler measurements that are updated relative to the micro-Doppler measurements based at least in part on a format for input to the second AI/ML model.

4. The wireless communication device of claim 1, wherein the indication of the second AI/ML model comprises one or more of:
an indication of one or more of an input format or an output format,
an indication of weights applicable to nodes of the second AI/ML model,
an indication of one or more layers to add to the second AI/ML model,
an indication of one or more parameters of the one or more layers to add,
an indication of an update to a convolution kernel,
an indication of a pooling operation, or
an indication of an activation function.

5. The wireless communication device of claim 1, wherein the indication associated with the object recognition comprises one or more of:
an indication of a recognized object,
an indication of measurements associated with the second AI/ML model, or
an indication of a substructure of the second AI/ML model.

6. The wireless communication device of claim 5, wherein the measurements associated with the second AI/ML models may include an intermediate layer of AI/ML model-based object recognition to be completed by a network node.

7. The wireless communication device of claim 6, wherein the network node comprises an additional wireless communication device or a computing device.

8. The wireless communication device of claim 5, wherein the indication of the update to the first AI/ML models comprises one or more of:
an update to the substructure, or
an indication of a position of the substructure within the first AI/ML model.

9. The wireless communication device of claim 1, wherein the one or more processors are further configured to cause the wireless communication device to:
identify a recognized object in association with an output of the second AI/ML model.

10. The wireless communication device of claim 1, wherein the one or more processors are further configured to cause the wireless communication device to:
transmit an indication of a third AI/ML model, the third AI/ML model being an update to the second AI/ML model, in association with local model training at the wireless communication device.

11. The wireless communication device of claim 10, wherein the indication of the third AI/ML model comprises:
an indication of one or more parameters of the third AI/ML model, the third AI/ML model being associated with an identified object or one or more parameters of the identified object.

12. The wireless communication device of claim 1, wherein one or more of the first AI/ML model or the second AI/ML model is associated with one or more of:
one or more supported micro-Doppler spectra,
a supported number of paths associated with the one or more supported micro-Doppler spectra, or
a threshold of one or more of supported delay spreads, Doppler shifts, angles of arrival, or signal strengths.

13. The wireless communication device of claim 1, wherein the micro-Doppler measurements comprise one or more of:
an indication of a recognized object,
an indication of a measurements associated with the first AI/ML model, or
an indication of a confidence of the first AI/ML model for object recognition.

14. The wireless communication device of claim 13, wherein the indication of the update to the first AI/ML model comprises an amount of updating that is associated with the confidence of the first AI/ML model for object recognition.

15. The wireless communication device of claim 1, wherein the one or more processors are further configured to cause the wireless communication device to transmit one or more of:
an indication of available storage for the second AI/ML model,
an indication of identified portions of the first AI/ML model for updating,
an indication of one or more parameters of the object recognition,
an indication of a request for further sensing in association with an output of the first AI/ML model or the second AI/ML model.

16. A wireless communication device for wireless communication, comprising:
one or more memories; and
one or more processors, coupled to the one or more memories, configured to cause the wireless communication device to:
receive an indication of micro-Doppler measurements associated with a first artificial intelligence or machine learning (AI/ML) model; and
transmit, in association with transmitting the indication of the micro-Doppler measurements, an indication of a second AI/ML model that is an update of the first AI/ML model.

17. The wireless communication device of claim 16, wherein the one or more processors are further configured to cause the wireless communication device to:
receive, in connection with use of the second AI/ML model, an indication associated with object recognition.

18. The wireless communication device of claim 16, wherein the first AI/ML model is associated with object recognition.

19. The wireless communication device of claim 16, object recognition is based at least in part on updated micro-Doppler measurements that are updated relative to the micro-Doppler measurements based at least in part on a format for input to the second AI/ML model.

20. The wireless communication device of claim 16, wherein the indication of the second AI/ML model comprises one or more of:
an indication of one or more of an input format or an output format,
an indication of weights applicable to nodes of the second AI/ML model,
an indication of one or more layers to add to the second AI/ML model,
an indication of one or more parameters of the one or more layers to add,
an indication of an update to a convolution kernel,
an indication of a pooling operation, or
an indication of an activation function.

21. The wireless communication device of claim 16, wherein the indication associated with object recognition comprises one or more of:
an indication of a recognized object,
an indication of measurements associated with the second AI/ML model, or
an indication of a substructure of the second AI/ML model.

22. The wireless communication device of claim 21, wherein the measurements associated with the second AI/ML models may include an intermediate layer of AI/ML model-based object recognition to be completed by the wireless communication device.

23. The wireless communication device of claim 21, wherein the indication of the update to the first AI/ML models comprises one or more of:
an update to the substructure, or
an indication of a position of the substructure within the first AI/ML model.

24. The wireless communication device of claim 16, wherein the one or more processors are further configured to cause the wireless communication device to:
receive an indication of a third AI/ML model, the third AI/ML model being an update to the second AI/ML model, in association with local model training at a wireless communication device.

25. The wireless communication device of claim 24, wherein the indication of the third AI/ML model comprises:
an indication of one or more parameters of the third AI/ML model, the third AI/ML model being associated with an identified object or one or more parameters of the identified object.

26. The wireless communication device of claim 16, wherein one or more of the first AI/ML model or the second AI/ML model is associated with one or more of:
one or more supported micro-Doppler spectra,
a supported number of paths associated with the one or more supported micro-Doppler spectra, or
a threshold of one or more of supported delay spreads, Doppler shifts, angles of arrival, or signal strengths.

27. The wireless communication device of claim 16, wherein the micro-Doppler measurements comprise one or more of:
an indication of a recognized object,
an indication of a measurements associated with the first AI/ML model, or
an indication of a confidence of the first AI/ML model for object recognition.

28. The wireless communication device of claim 27, wherein the indication of the update to the first AI/ML model comprises an amount of updating that is associated with the confidence of the first AI/ML model for object recognition.

29. A method of wireless communication performed by a wireless communication device, comprising:
transmitting an indication of micro-Doppler measurements associated with a first artificial intelligence or machine learning (AI/ML) model;
receiving, in association with transmitting the indication of the micro-Doppler measurements, an indication of a second AI/ML model that is an update of the first AI/ML model; and
transmitting, in connection with using the second AI/ML model, an indication associated with object recognition.

30. A method of wireless communication performed by a wireless communication device, comprising:
receiving an indication of micro-Doppler measurements associated with a first artificial intelligence or machine learning (AI/ML) model; and
transmitting, in association with transmitting the indication of the micro-Doppler measurements, an indication of a second AI/ML model that is an update of the first AI/ML model.
